(19) United States
(12) Patent Application Publication
(10) Pub. No.: US 2024/0296602 A1
(43) Pub. Date: Sep. 5, 2024

(54) SYSTEM AND METHOD FOR IMAGE ANNOTATION

(71) Applicant: RAKUTEN SYMPHONY SINGAPORE PTE. LTD., Singapore (SG)

(72) Inventors: Rajat MEHRA, Indore (IN); Prachi SINGH, Indore (IN); Varsha RAJPOOT, Indore (IN); Rounak LAHOTI, Indore (IN)

(73) Assignee: RAKUTEN SYMPHONY SINGAPORE PTE. LTD., Singapore (SG)

(21) Appl. No.: 17/917,017

(22) PCT Filed: Apr. 21, 2022
(86) PCT No.: PCT/US2022/025711

§ 371 Date: Oct. 5, 2022

(51) Int. Cl. G06T 11/20; G06F 3/04845; G06T 11/60

(52) U.S. Cl. CPC G06T 11/203; G06F 3/04845; G06T 11/60

(57) ABSTRACT

This disclosure provides methods, apparatuses, and computer-readable mediums for annotating an image. In an aspect, a method comprises retrieving an input image; displaying a canvas to a user containing said input image and a plurality of Shapes, wherein for each Shape in said plurality of Shapes a Shape class is defined which has its own logic to draw, edit and move the Shape; receiving one or more inputs corresponding to the addition of one or more Shapes at one or more coordinates; storing the one or more Shapes and their coordinates in JavaScript Object Notation (JSON) on a Shape list; and traversing the Shape list to draw on the canvas all stored Shapes on the input image.

### TECHNICAL FIELD

The present disclosure relates to methods and systems for annotation of images in a mobile application.

### BACKGROUND

It is often helpful in communicating information to refer to particular locations within images. In these situations the communication can be facilitated by using symbols or text to point things out in the image to other participants in the communication. In the context of telecommunications, for example, images of potential locations where network equipment may be installed might be annotated with notations or graphical objects representing the network equipment.

Related art methods and systems for annotating such images, however, do not provide a convenient, simple, and efficient method for annotating images. For example, image annotation systems in the related art do not incorporate telecommunication related shapes and objects. Accordingly, related art methods and systems require a user to use multiple third-party applications to edit the image to get the desired output in the image, and require the user to upload and re-upload the image document multiple times thereby leading to distortions in the image.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for annotation of images in a mobile application are provided by the present disclosure.

Aspects of one or more embodiments allow a user to avoid the time-consuming process of saving an updated bitmap of an image with each annotation by providing methods and systems for annotation of images using JavaScript Object Notation (JSON).

Aspects of one or more embodiments allow annotations to be stored and saved in JSON format for later output of a bitmap of an annotated image.

According to embodiments, a method of annotating an image includes: retrieving an input image: displaying a canvas to a user containing said input image and a plurality of Shapes, wherein for each Shape in said plurality of Shapes a Shape class is defined which has its own logic to draw, edit and move the Shape; receiving one or more inputs corresponding to the addition of one or more Shapes at one or more coordinates: storing the one or more Shapes and their coordinates in JavaScript Object Notation (JSON) on a Shape list; and traversing the Shape list to draw on the canvas all stored Shapes on the input image.

According to embodiments, an apparatus for annotating an image includes: a memory storage storing computer-executable instructions; and a processor communicatively coupled to the memory storage, wherein the processor is configured to execute the computer-executable instructions and cause the apparatus to: retrieve an input image: display a canvas to a user containing said input image and a plurality of Shapes, wherein for each Shape in said plurality of Shapes a Shape class is defined which has its own logic to draw, edit and move the Shape: receive, from the user, one or more inputs corresponding to the addition of one or more Shapes at one or more coordinates: store the one or more Shapes selected by the user in JavaScript Object Notation (JSON) in a Shape list; and traverse the Shape list to draw on the canvas one by one all stored Shapes on the input image.

According to embodiments, a non-transitory computer-readable medium contains instructions, which when executed by one or more processors cause an apparatus to: retrieve an input image: display a canvas to a user containing said input image and a plurality of Shapes, wherein for each Shape in said plurality of Shapes a Shape class is defined which has its own logic to draw, edit and move the Shape: receive, from the user, one or more inputs corresponding to the addition of one or more Shapes at one or more coordinates: store the one or more Shapes selected by the user in JavaScript Object Notation (JSON) in a Shape list; and traverse the Shape list to draw on the canvas one by one all stored Shapes on the input image.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example device useful for implementing image annotation in accordance with embodiments of the present invention;

FIG. 2 is an example flow diagram for image annotation using JSON in accordance with embodiments of the present invention:

FIG. 3 illustrates an example of an input image in accordance with embodiments of the present invention;

FIG. 4 illustrates an input image drawn on a canvas with a plurality of Shapes in the side panel in accordance with embodiments of the present invention:

FIG. 5 illustrates clicking on an example antenna Shape to select it in accordance with embodiments of the present invention:

FIG. 6 illustrates tapping on the canvas to place the example antenna Shape at a user-desired location in accordance with embodiments of the present invention:

FIG. 7 illustrates additional example varieties of Shapes in a Shape list placed on the canvas in accordance with embodiments of the present invention:

FIG. 8 illustrates an output image bitmap combining the input image and the Shape list in accordance with embodiments of the present invention; and

FIG. 9 illustrates an exemplary device useful for implementing image annotation in accordance with embodiments of the present invention.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In a related art, a user seeking to annotate an image on a mobile device must navigate multiple third-party applications and repeatedly save bitmaps containing the annotation then transmit the bitmaps over a network connection for the purpose of uploading to some network location. In the process, image quality is lost and distortion is introduced.

Example embodiments of the present disclosure allow a user to avoid the time-consuming process of saving an updated bitmap of an image with each annotation by providing methods and systems for annotation of images using JavaScript Object Notation (JSON). According to the methods and systems of one or more embodiments, annotations can be stored and saved in JSON format for later output of a bitmap of an annotated image. This results in a substantially improved user experience during image annotation with less latency and fewer technical glitches.

Advantageously, the embodiments described below provide for using JSON to achieve one or more tasks. In addition, the present disclosure may provide an experience which is pleasing to the user and easily operable for the creation, modification, and execution of image annotation. In addition, quickly changing requirements may be met and image annotation may be deployed in a manner that may minimize waiting time, resulting in an improved user experience. Furthermore, the use of JSON for image annotation may yield execution times that may be faster when compared to other conventional methodologies.

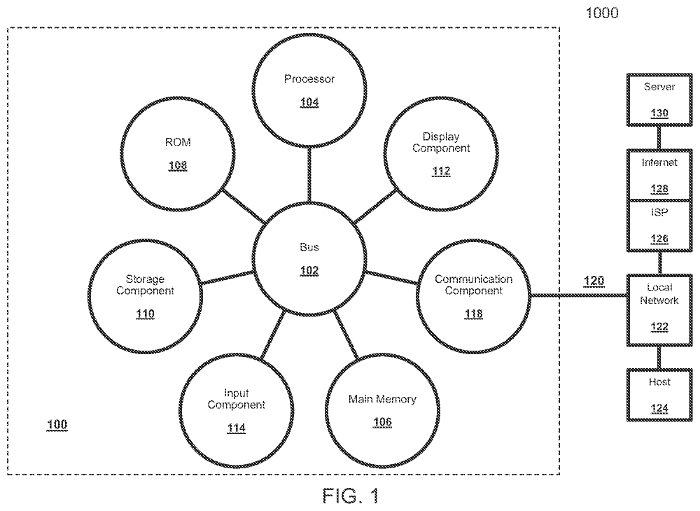

FIG. 1 illustrates a system 1000 including a device 100 on which embodiments can be implemented. Device 100 includes a bus 102 or other communication mechanism for communicating information, and microprocessor 104 coupled with bus 102 for processing information.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a liquid-crystal display (LCD), light emitting diode (LED) display, LED-backlit display, organic light emitting diode (OLED) display, active matrix OLED (AMOLED) display, plasma display, cathode ray tube (CRT), etc., for displaying information to a computer user. An input device 114, which can include alphanumeric and other keys, is coupled to bus 102 for communicating information and command selections to processor 104. Another type of user input device is used for cursor control such as a mouse, a trackball, a trackpad, or cursor direction keys for communicating direction information and command selections. Further, the input device 114 may include a touchscreen (e.g., in conjunction with the display 112). Processor 104 can receive signals from input device 114 for controlling cursor movement and calculate associated changes to display 112. A cursor control input device typically has two degrees of freedom in two axes, a first axis (e.g., x) and a second axis (e.g., y), that allows the device to specify positions in a plane.

Computer system 100 may implement the techniques described herein using customized hard-wired logic, one or more ASICs or FPGAs, firmware and/or program logic which in combination with the computer system causes or programs computer system 100 to be a special-purpose machine. According to at least one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process operations described herein.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In at least one such implementation, communication interface 118 sends and receives one or more of electrical, electromagnetic and optical signals (as with all uses of “one or more” herein implicitly including any combination of one or more of these) that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the network(s), network link 120 and communication interface 118. In at least one embodiment of the Internet example, a server 130 might transmit a requested code for an application program through Internet 128, ISP 126, local network 122 and communication interface 118.

In embodiments, the received code may be one or more of executed by processor 104 as it is received, and/or stored in storage device 110, or other non-volatile storage for later execution.

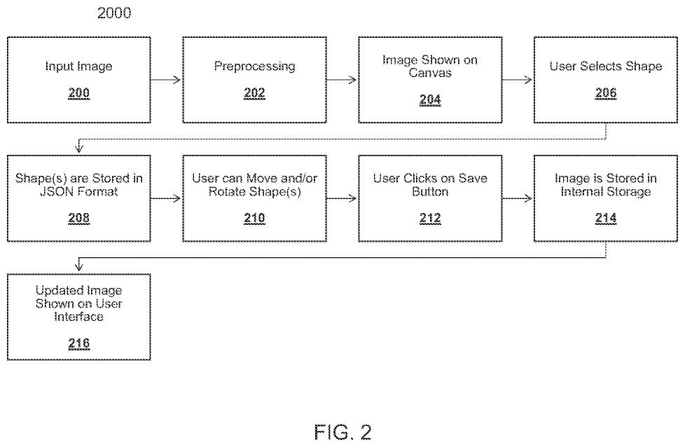

FIG. 2 is an example flow diagram 2000 for image annotation using JSON in accordance with embodiments of the present invention.

At Block 200 of FIG. 2, an input image is selected. The image could be selected from a disk, but the disclosure is not so limited. In some embodiments, the image could be selected from a web application. Using Local network 122 and Internet 128 of FIG. 1, electrical, electromagnetic or optical signals can carry digital data streams encoding images for use as input images in embodiments. Using input device 114 of FIG. 1, the input image can be selected by a user but does not have to be selected by a user. An algorithm can also be employed to select an input image based on a variety of parameters related to the time, place, or other ambient condition occurring during the operation of embodiments. Algorithms like convolutional neural networks, also known as convnets or CNNs, can handle enormous datasets of images and optimize selection of a particular image(s) for use at Block 200 of FIG. 2.

At Block 202 of FIG. 2, image preprocessing occurs. Operations including but not limited to resizing, reorienting, and color corrections are performed. Image preprocessing is a term for operations on images at the lowest level of abstraction. These operations do not increase image information content but they decrease it if entropy is an information measure. The aim of preprocessing is an improvement of the image data that suppresses undesired distortions or enhances some image features relevant for further processing and analysis task. Preprocessing techniques may include, for example, at least one of image reorientation, image size compression, canvas creation, canvas resize, canvas reorientation, etc.

At Block 204 of FIG. 2, the preprocessed image is shown on a canvas element as found in an exemplary embodiment. A canvas consists of a drawable region defined in code with height and width attributes. JavaScript code may access a canvas and perform drawing functions (other 2D and 3D APIs may also be utilized), thus allowing for dynamically generated graphics. In other words, graphics are coded in JavaScript to change based on dynamic variables which are updated over an interval. A canvas can be used for building graphs, animations, games, and image composition among other tasks. Scripts with a resolution-dependent bitmap canvas can be used for rendering graphs, game graphics, art, or other visual images on the fly.

The preprocessed image shown on the canvas element is rendered on a user interface (UI) (e.g., display 114 of exemplary device 100 in FIG. 1). Rendering the UI view may be partitioned into one or more pages and each page may be partitioned into one or more sections. In such an example, the layout information may indicate which resources correspond to each page and/or section of the UI view. In some embodiments, if or when the UI view is rendered (e.g., executed), the UI view may display one page at a time and may provide navigational buttons to move between the pages. In other embodiments, if or when the UI view is rendered, the UI view may display two or more pages simultaneously. Alternatively or additionally, sections of the UI view may be arranged horizontally, vertically, and/or in an overlapped manner. In other optional or additional embodiments, one or more sections of the UI view may be conditionally displayed. That is, a section of the UI view may be shown and/or hidden based on a condition being met (e.g., a particular field and/or parameter is set to a particular value). Alternatively or additionally, a section of the UI may be enabled (e.g., input may be permitted) and/or disabled (e.g., input may not be permitted) based on a condition being met. The disclosure is not limited in this regard.

Horizontal positioning information and/or vertical positioning information for elements (i.e., text and graphics) in a UI differs between embodiments. The positioning information may be indicated relative to a predetermined point (e.g., origin) of the UI view, of a section of the UI view, and/or a page of the UI view, such as, but not limited to, a top-left corner, a center point, or a bottom-right corner. Alternatively or additionally, layout information may comprise layering information (e.g., z-order). In other embodiments, the horizontal positioning and/or vertical positioning may be determined based on automated scripts which dynamically update. For example, an element may be displayed on a top of a UI, and a second element may be displayed on bottom of a UI. In another example, the first element may be displayed on a righthand side of a UI view, and the second element may be displayed to the lefthand side.

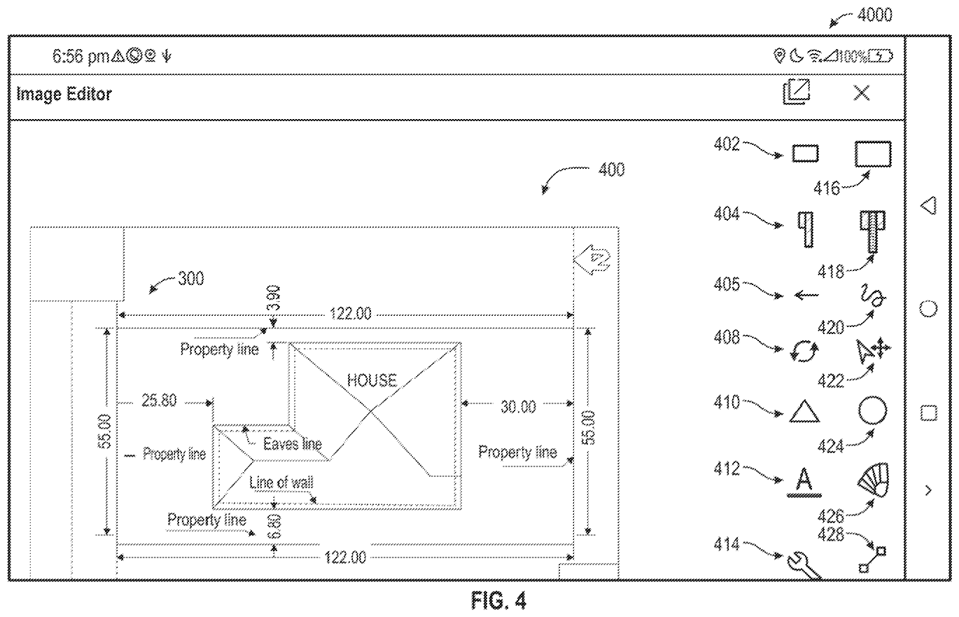

At Block 206 of FIG. 2, the user selects a Shape. The Shape can be any one of a nearly unlimited number of different styles. Exemplary Shapes in the exemplary embodiment of FIG. 4 are described in detail below. Though FIG. 4 provides an exemplary UI on which exemplary Shapes can be found, the present disclosure is not so limited. Shapes could be found in many different configurations on a UI, and could be selected in a variety of fashions, such as through the internet of things (IOT), augmented reality (AR—an interactive experience of a real-world environment where the objects that reside in the real world are integrated into a computerized environment), artificial intelligence (AI) or virtual reality (VR).

At Block 208 of FIG. 2, Shapes are stored in JavaScript Object Notation (JSON) format. Shape object in JSON notation has a number of properties. Closed is a boolean value that dictates whether a shape is open or closed. Fill is a boolean that determines whether the shape has been filled. A shape must be closed to be filled. Weight gives the thickness of the shape's outline. The position for a two-dimensional object indicates the x/y position of the shape.

The above shape metadata is used to draw a shape along a defined path, or outline. This can be done using the JSON ‘path’ property, where paths are an array of path segments. A Path segment is a section of an overall shape. For example, it can be line and curve segments. To define the type of segment, there can be defined an ‘order’ which is specified as a number. An order of 1 corresponds to a linear segment, and higher orders can used to introduce cubic and quadratic curves, for example. Once the user has specified the type of path segment the user desires, there must be defined an array of points used to draw the segment.

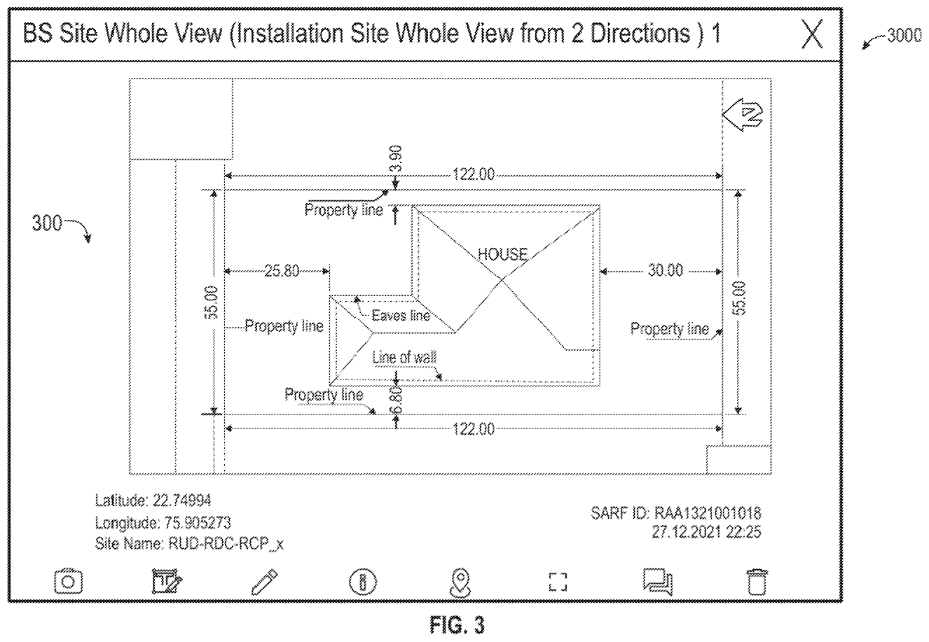

Though the exemplary embodiment given in FIGS. 3-8 is depicted in two dimensions, the present disclosure can be applied as well with a higher number of dimensions, in which case additional parameters need be defined. Resolution determines the quality of the resulting 3d mesh. It is used when sampling the 2d image to construct the 3d geometry. A higher number creates a more detailed mesh, however this comes at the expense of a larger file size, and it also takes more time to compute.

At Block 210 of FIG. 2, the user can move or rotate one or more Shape(s). Commands from the user to move or rotate one or more Shape(s) can be received via the input device e.g., input device 114 in the exemplary device of FIG. 1. For example, the requests may comprise common graphical interface operations (e.g., “drag-and-drop” operations and the like) that indicate an intention by the user to move or rotate one or more Shape(s). Keyboard shortcuts could also be employed, e.g., the R key could trigger the rotation of selected Shape(s).

Upon receiving a command from a user to move or rotate one or more Shape(s), the JSON encoding the corresponding Shape(s) is updated, once the user ceases operation of the movement or rotation operation. A UI may also be configured to dynamically update the position of the Shape on the display as the user operates a cursor in one direction or another. The arrays of points used to draw the segments of the Shape(s) can be stored in JSON without the need the output a new bitmap file for each movement and/or rotation operation.

At Block 212 of FIG. 2, the user clicks on the save button. Save is writing data to a storage medium, such as a floppy disk, CD-R, USB flash drive, or hard drive. The save option is found in almost all programs commonly under the “File” drop-down menu or through an icon that resembles a floppy diskette. When clicking the Save option, the file is saved as its previous name. However, if the file is new, the program asks the user to name the file and where to save the file. Unless the program the user is using automatically saves as the user are working, if a file is not saved it is lost. For example, if the computer loses power, or the computer must be rebooted, the work is lost. While the user is working, data is saved in RAM, which is a fast, volatile memory device. It is called “volatile” because RAM loses its data when its power source is lost or turned off. In contrast, storage medium or disk is “non-volatile” storage, because it retains its data even when powered off. Thus, before the user's action at Block 212 of FIG. 2, image annotation data is stored in RAM but is not durably stored for future retrieval.

At Block 214 of FIG. 2, the image and Shape(s) are stored in internal storage, in response to the user's action at Block 212. A computer's internal drive is designed to operate much faster than an external drive. An internal drive is connected to a computer's bus. This connects internal storage directly to the motherboard, and allows data to be transferred at a faster rate compared to external drives. Though internal storage of the device is utilized in the exemplary embodiment of FIG. 2, nevertheless utilization of external storage is also possible and is employed in other embodiments. The image and Shape(s) in Block 214 of FIG. 2 are stored in several bytes all corresponding to the underlying digital data and according to the specifications of the file type.

At Block 216 of FIG. 2, an updated image is shown on the user interface comprising the input image and the Shape(s) as selected and positioned by the user. After this operation the user may continue to perform the operations described in FIG. 2 with additional images, returning to Block 200, or may continue to select Shape(s) as in Block 206 or move and rotate Shape(s) as in Block 210. The user may also proceed to create a bitmap file encoding the updated image shown on the user interface.

FIG. 3 illustrates an example screen 3000 including an input image 300. Input image 300 can be, for example, retrieved from internal or external storage or received over a network communications interface. Input image 300 can be in various file formats including but not limited to jpg, .jpeg, tiff, .gif, .svg, .svgz, bmp, .png, and .tif. Images may be partitioned into one or more pages and each page may be partitioned into one or more sections. A user may select input image 300 according to graphical guidance (i.e., an icon), keyboard commands, voice commands, or other means.

In this exemplary embodiment, input image 300 depicts an architectural-style drawing, such as a survey, which depicts locations within a building and significant locations outside the building, such as the boundary of the property line for the lot on which the building sits. Annotation of input image 300 is useful for describing and communicating information related to the building's infrastructure.

FIG. 4 shows an example screen 4000 in which an input image 300 is placed upon a canvas 400 according to an embodiment. Alongside canvas 400 are Shapes 402-428. A Shape class (superclass) is defined with common fields and methods (x-y location, rotation, color, drawing method, etc.). A certain, predetermined number of subclasses, corresponding to various Telecom Shapes 402-428 in the exemplary embodiment of FIG. 4, are defined. Each subclass includes fields unique to that shape. For example, for a circle Shape, its radius; for a text Shape, the text string; and for an antenna Shape, its height and width.

Shape 402 is an unfilled rectangle. It is described elsewhere in this specification how to encode an unfilled rectangle. According to those techniques described herein this shape is provided with the Boolean “fill” operator for a shape in JSON to be set to no.

Shape 416 is a filled rectangle. According to the techniques described herein this shape is provided with the Boolean “fill” operator for a shape in JSON to be set to yes.

Shape 404 is a directional antenna. It is useful for persons in the telecommunications industry to distinguish between directional and omnidirectional antennas. Therefore, an embodiment is provided which combines two filled rectangles in colors designed to easily convey to a user that the Shape is a directional antenna. The shape of the filled rectangles representing the directional antenna as well as the colors can be encoded in JSON.

Shape 418 is an omnidirectional antenna. Shape 418 consists of three filled rectangles, two smaller rectangles adjacent on either side to the central rectangle. The omnidirectional antenna in an exemplary embodiment is provided in similar coloring to the directional antenna in order to make it easier for the user to identify the location of an antenna.

Shape 406 is an arrow shape. The arrow shape is a combination of three lines, two smaller diagonal lines coming to a point at the end of a third line. An arrow can be useful to point out a particular location or show information about the direction of movement.

Shape 420 is a “squiggly” line shape. This shape can be used to draw in freehand without straight lines. This shape allows the user maximum flexibility in fashioning annotation and indeed the flexibility can be nearly unlimited for creating any computer-generated image.

Icon 408 is a reset icon. Icon 408 is used to delete all the Shapes drawn on the base image.

Shape 422 is a movement shape, and can be used to modify other shapes. In the case of Shape 422, it can be used to translocate the coordinates of other shapes.

Shape 410 is a triangle shape which the user may select. By operation of this shape, JSON is used to encode the parameters of a triangle selected by the preference of a user through input received from the user and calculated by the processor.

Shape 424 is a circular shape which may be advantageous to a user in highlighting some particular location in a drawing. By defining radius and center a circle may also be encoded in JSON.

Shape 412 allows a user to add text to an image. A variety of font sizes and styles could be made available to a user. By operation of a cursor and/or keyboard, a user can be provided with the advantage of being able to place text anywhere on the canvas, which may in embodiments extend beyond the bounds of the image to allow for placement of text in adjacent whitespace. Text locations and styles can also be encoded in JSON providing significantly improved ease of annotation.

Shape 426 is a fan-shaped icon which represents a coverage area. Shape 426 relies on the capability of JSON to encode arc shapes of various color and thickness. Shape 426 can be used by persons in the telecommunications industry to indicate the direction of propagation of the signal of a telecommunications service. Shape 426 can be used in conjunction with Shape 404 to show propagation of service from a directional antenna.

Icon 414 is a setting icon that can be used to change the stroke width of shapes and the text style and text size of text shapes.

Shape 428 is a line shape which can be used to draw straight lines. Shape 428 is similar in operation to Shape 420 except that the placement of Shape 428 is limited to those points which fall on a line and therefore bear a y=mx+b linear relation.

Though each of Shapes 402 through 428 are provided in exemplary two-dimensional format, equivalents in higher dimensions are also possible and can be created by sampling two-dimensional planes. FIG. 4 is only a simple embodiment and more advance functionality can be found in other embodiments. For example, calculations defining Shapes can be made to depend on a host of other parameters including the presence and location of other Shapes. Though FIGS. 4-8 are meant to depict only the simplest features of the present disclosure for ease of understanding, operations such as scaling for example are present in more complex embodiments of the present disclosure.

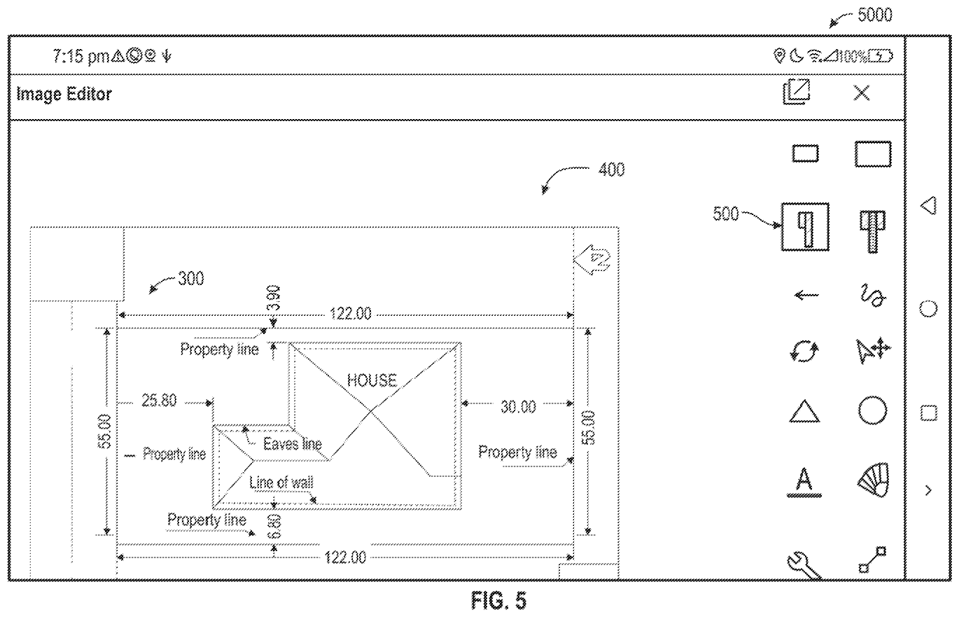

FIG. 5 shows an example screen 5000 including the UI of FIG. 4 with Selected Shape 500 having been chosen by a user. The selection can occur through an input device by input from a user or via other means as described herein such as augmented reality in which a user might touch some tangible object in the real world to trigger the selection. For example, a person in the telecommunications industry may be in proximity to some telecommunications equipment within a building, and a signal from such telecommunications equipment received by a device configured for embodiments of the present invention could cause the selection of a Shape.

Once the user performs an operation to indicate selected Shape 500, the user may position selected Shape 500 anywhere on canvas 400 including at any location on the input image or in the adjacent whitespace on canvas 400.

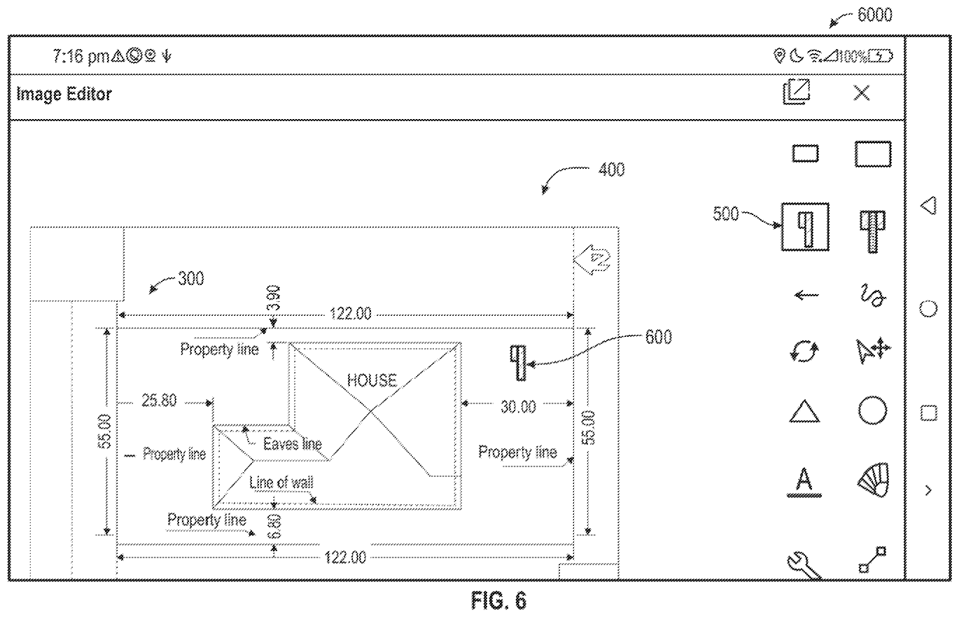

FIG. 6 illustrates an example screen 6000 including input image 300 on canvas 400 along with Shape 600 which is on a Shape list. A shape list is a listing of shapes in Javascript Object Notation (JSON). Adding Shape 600 to the JSON Shape list has many advantages as detailed in the present disclosure.

Shape 600 is added to the Shape List by the user in FIG. 6. Shape 600 first is positioned at a user-desired location on the input image according to an input device, augmented reality, or otherwise. The placement of Shape 600 can be used to indicate the location of a directional antenna to persons in the telecommunications industry.

JavaScript can be used to draw the Shapes on the Shape List. For example, a rectangle can be drawn in black color 20 pixels by 40 pixels:
var example=document.getElementById(‘example’):
var context=example.getContext(‘2d’);
context.fillStyle=‘black’:
context.fillRect(20, 20, 40, 40);
More complicated shapes can be constructed in a like manner combining simpler shapes.

The shape added to the image as an annotation can be stored in JavaScript Object Notation (JSON), which could be as short as the few lines of exemplary code listed above. Using the present invention, therefore, allows a user to be able to simply store the annotation-which could use only byte-quantity data amounts, a substantial advantage in storage and/or transmission. On the other hand, if the user must save and/or transmit a new bitmap with a shape added, the amount of data which must be stored and/or transmitted is generally in the range of millions of times higher. Thus, adding a Shape to the Shape list is a far more convenient procedure than would have to be undertaken to output a bitmap with the same appearance.

When input image 300 is being annotated, a JSON file stores an indication of the base image/canvas according to the file name or file path of base image and a Shape List. An image can be directly encoded in JSON, but a large amount of data would be required for encoding. Thus, rather than directly encoding input image 300 in JSON, input image 300 is indicated in JSON by the file name or file path of input image 300.

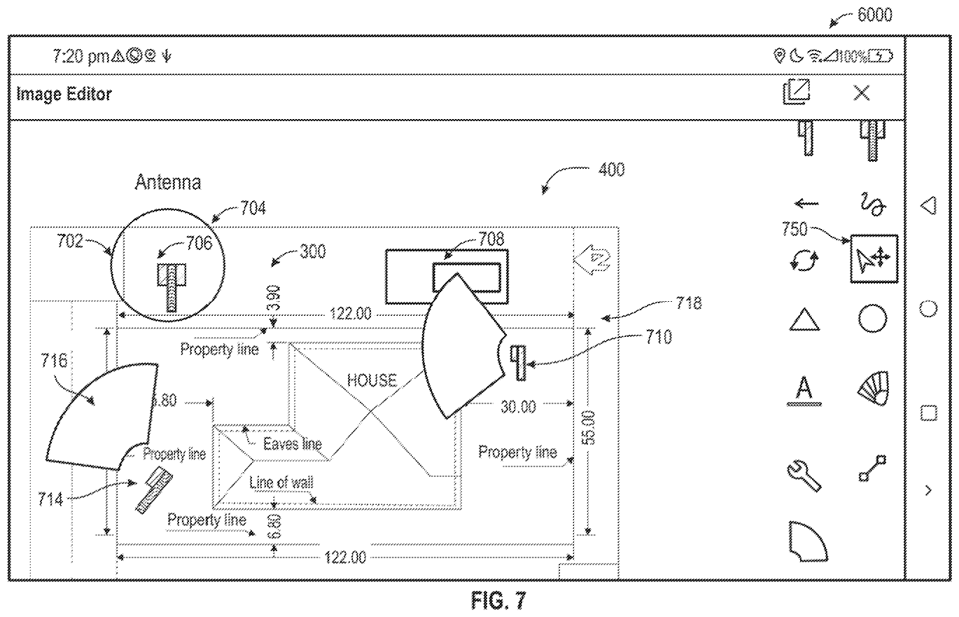

FIG. 7 illustrates an example screen 7000 with additional example varieties of Shapes in a Shape list placed on the canvas in accordance with embodiments. Referring to FIG. 7, there are multiple Shapes on the shape list. When input image 300 is being annotated, one Shape list (Java list) is created with input image 300 as the first object in the list, with file path of input image 300. All other shapes are stored in the Shape list sequentially after base image.

Shape 702 is a circle Shape positioned on input image 300 in the upper left-hand corner of the UI. Circle Shape 702 is defined by a radius and an x,y coordinate indicating the horizontal and vertical positioning of the circle's center.

Shape 704 is a text Shape positioned mostly within Shape 702 and slightly overlapping it. One or more Shapes may be positioned overlayed upon one or more other Shapes, in which case predefined parameters determine which Shape appears as the front layer thereby masking the colors of other Shapes in lower layers. The text of Shape 704 reads “Antenna”. In embodiments the textual content of text Shapes such as Shape 704 can be displayed in a variety of colors, fonts, and sizes.

Shape 706 is an omnidirectional antenna Shape. Though located on a UI inside of circle Shape 702, omnidirectional antenna Shape does not overlap the coordinates of any other Shape. FIG. 7 is understood as a schematic only, but in other embodiments more complex calculations can be performed to indicate detailed information about the range of telecommunications service of a device such as a directional antenna.

Shape 708 is a filled rectangle Shape. It may indicate, for example, the presence of objects whose locations might be important for a person in the telecommunications industry to know. There may be a need for example to avoid placing telecommunications equipment in the location of certain areas which might be denoted by filled rectangles in black color.

Shape 710 is a directional antenna Shape. Shape 710 for example could indicate service points for telecommunications service. A directional antenna, modifies or “directs” the signal, towards a very specific location, not only increasing the gain, but also reducing unwanted reception or interference from surrounding Wireless devices. Sometimes, a directional antenna is used even in situations where the customer doesn't necessarily need to broadcast a signal at an exact area, but more to reduce or eliminate nearby interference or wireless signals on the same channel.

Shape 712 is a coverage area Shape. Though the example embodiment provided is meant to convey mainly qualitative iconographic information, in various embodiments there may be a greater or lesser use of quantitative information calculated and displayed. It is possible to calculate and depict to scale boundaries of telecommunications service acceptable at a certain threshold. For example, service boundaries can be displayed for a telecommunications access point that transmits radio signals through an antenna and generates a wireless network coverage area around the antenna, the signal strength becoming weaker as radio signals are transmitted further. An edge field strength can be defined such that the area where the signal strength around an antenna is greater than the edge field strength is depicted as the coverage area of a coverage area Shape. The field strength of radio signals at the edge of a network coverage area is called edge field strength. For example, the boundaries of a coverage area Shape could be drawn where the edge field strength is −60 dBm.

Shape 714 is a second directional antenna Shape. It can be seen in FIG. 7 that Shape 714 is positioned on the opposite side of the building (house) depicted in input image 300. It may be desirable to position antennas at some distance from each other or on opposite sides of a structure in order to maximize coverage and avoid interference.

Shape 716 is a second coverage area Shape. In some embodiments a second coverage area may overlap a first coverage area. Similarly additional antennas could be added beyond the second in which case a combined field strength resulting from multiple antennas could be modeled. The coverage area of omnidirectional antennas is measured by coverage radius, while the coverage area of directional antennas is measured by coverage distance. Radio transmit power and signal strength can be measured and/or calculated and the calculations used in embodiments for the placement and/or creation of Shapes.

Shape 718 is an arrow Shape. It is drawn with the head of the arrow pointed at the property line in input image 300. It may be important in the telecommunications industry to know the location of a property line marking a lot with or without an improved building in order to plan telecommunications service and locate telecommunications; thus, an arrow Shape like Shape 718 may be useful for clearly marking a property line and aiding a user's ability to easily perceive the property line.

As the user manipulates the UI shown in FIG. 7, Shapes are added to a Java Shape list. While converting this Java Shape list into JSON, an object is created which has one input image (i.e., input image 300) and lists of different types of Shapes. An exemplary structure found embodiments is the below structure in JSON, where x represents the horizontal positioning and y represents the vertical positioning:

### JSON Object

BaseImage image: (with file path, x, y, height, width and other attributes of the Base image)
List<Rectangle> rectangleList: (with x, y, height, width and other attributes of the Rectangle(s))
List<Text> textList: (with x, y, text and other attributes of the Text(s))
List<Circle> circleList: (with x, y, radius and other attributes of the Circle(s))

The code in the Shape list in Java can be used for rendering purposes. The colors contained in Shapes are composited with input image 300. The collection of shapes, text, and images are represented by coloring pixels on a screen or printer according to the layers in the image. In embodiments, layers are the different levels at which one can place an object or image file. Layers can represent a part of a picture, either as pixels or as modification instructions. Layers can be stacked on top of each other, and depending on the order, determine the appearance of the final picture. Layers can be stacked, merged, or defined when creating a digital image. Layers can be partially obscured allowing portions of images within a layer to be hidden or shown in a translucent manner within another image. Layers can also be used to combine two or more images into a single digital image. Each Shape can be its own layer, or two or more Shapes can be grouped into a layer.

JSON Object format is often used in embodiments to store the data in Shape list. JSON object format can be conveniently used to store data in a database or to transmit data on a server. Many programming languages provide implementations for JSON. Popular languages such as PHP, Python, C#, C++, and Java provide good support for the JSON data interchange format. Popular programming languages commonly used in the art rely on JSON and its implementation for data transfer, and thus have provide good support for JSON. Therefore, the present disclosure allows for image annotations to be processed and utilized with ease in a wide variety of different web applications and within and among organizational (i.e., corporate) networks.

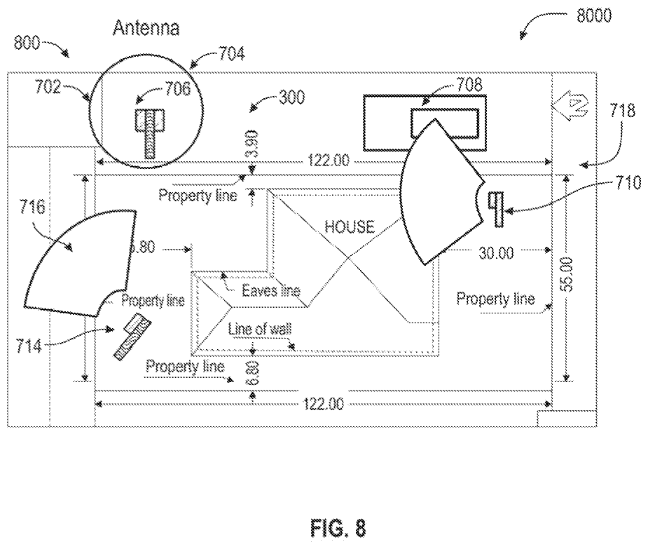

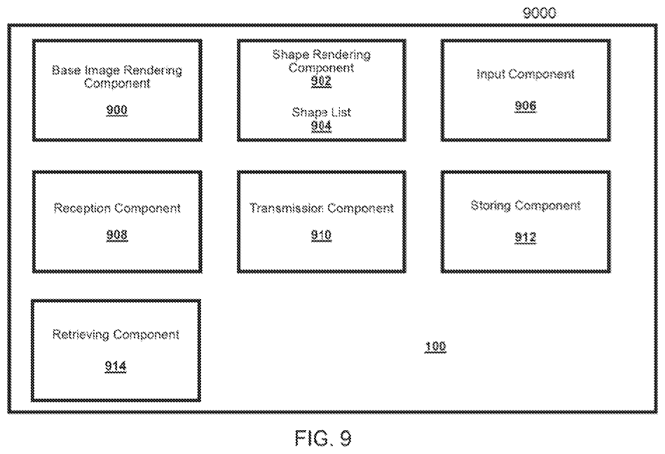

FIG. 8 illustrates an example screen 8000 including an output image 800 according to one or more embodiments. Output image 800 can be encoded in a variety of file formats useful for storing bitmaps of images such as .jpg, .jpeg, tiff, gif, .svg, .svgz, bmp, .png, and .tif. Output image 800 can be rendered for example by the devices illustrated in FIG. 1 and FIG. 9.

As explained with reference to FIG. 7, one Shape may completely cover another shape as represented on a UI. For example, black filled rectangle Shape 708 may be positioned in front of another shape, obscuring the other shape from view in the UI. Whereas a Shape list in JSON format can store all layers in an image, output image 800 in FIG. 8 consists of only visible layers. Thus, when output image 800 is generated, data representing output image 800 represents only pixel by pixel values which do not take into account non-visible layers. This is another advantage of working the present invention because the techniques provided by the present disclosure allow for a user to durably store and save information represented in non-visible layers which could be lost if annotations were stored only as a bitmap. JSON is able to durably store Shapes on the Shape list whether or not visible in output image 800.

In FIG. 8, a user can set a custom output file name for each render job within the JSON data source by using an output property key. An output image can be generated and transmitted via a communications link like that of network link 120 in FIG. 1. The file name can depend on variable like the time at which the rendering job was instantiated. By such an output property key other parameters related to the bitmap output can also be set such as resolution and image size.

FIG. 9 illustrates a block diagram 9000 of arithmetic and logic units within a device, such as device 100 illustrated in FIG. 1 containing processor 104, configured for an example embodiment.

Base image rendering component 900 causes the display of a bitmap of a base image on a UI. A UI view may be executed by base image rendering component 900 and presented (e.g., displayed) to a user. Each pixel displayed on a display screen connected to base image rendering component 900 corresponds directly to the bits computed in base image rendering component 900. Image caching can be used in some embodiments to reduce latency and improve performance. A memory and disk cache can often help with performance, allowing components to quickly reload processed images. The present disclosure is particularly well suited for caching as the changes to an image displayed on a UI via the addition of Shapes are made with a JSON Shape list and input image 300 for example can be cached. A memory cache can offer fast access to bitmaps at the cost of taking up valuable application memory. A disk cache can be used to persist processed bitmaps and help decrease loading times where images are no longer available in a memory cache though retrieving images from disk is slower than loading from memory. A cache is beneficial to avoid having to process images again so the user has a smooth and fast experience when a configuration change occurs. Images populate the activity almost instantly from memory when the cache is retained.

Shape rendering component 902 displays an overlay of Shape list 904 upon the base image rendered by base image rendering component 900. A UI view created by base image rendering component 900 may be modified by Shape rendering component 902 and presented (e.g., displayed) to a user. Shape rendering component 902 parses Shape list 904 which is in JSON format. The base image computed by base image rendering component 900 is always the first Shape on Shape list 904. Shape list 904 is read by Shape rendering component 902 and each pixel displayed on a display screen UI connected to Shape rendering component 902 corresponds directly to the positions computed in Shape rendering component 902.

Shape list 904 is stored within Shape rendering component 902. Shape list 904 is easily stored in JSON format in memory with only a small amount of data required. It can comprise for example Shapes as described in FIGS. 1-8 e.g. Shapes in the format of Shapes 402-428. A huge variety of other shapes are also possible in embodiments and may be customized for use in a particular industry. As disclosed, JSON can be used flexibly to deploy Shapes created for particular applications. In an example embodiment, telecommunications-related shapes are disclosed, but there are many other industries in which the techniques of the present disclosure could find application.

Input component 906 receives input from a user. Input could be received for example at a keyboard or a cursor control apparatus as input component 906 may include one or more components that permit a device (e.g., device 100) to receive information, such as via user input (e.g., a touch screen, a keyboard, a keypad, a mouse, a stylus, a button, a switch, a microphone, a camera, and the like). Alternatively or additionally, the input component 906 may include a sensor for sensing information (e.g., a global positioning system (GPS) component, an accelerometer, a gyroscope, an actuator, and the like) which information can be used for adding or modifying Shapes on the Shape list. Input component 906 calculates a user's desired updates to Shape list 904 for use by Shape rendering component 902. For each input by a user through input component 906 altering Shape list 904 a UI view is computed by Shape rendering component 902.

Reception component 908 is configured to receive communications (e.g., wired, wireless) from another apparatus. Reception component 908 may receive communications, such as control information, data communications, or a combination thereof, from another apparatus. Reception component 908 may provide received communications to one or more other components such as base image rendering component 900 and/or Shape rendering component 902. In some aspects, the reception component 1202 may perform signal processing on the received communications, and may provide the processed signals to the one or more other components. In some embodiments, the reception component 1202 may include one or more antennas, a receive processor, a controller/processor, a memory, or a combination thereof. By reception component 908, an input image (i.e., input image 300 of FIG. 3) can be received at base image rendering component 900. It is also possible to receive a Shape list in JSON format by reception component 908. This can be particularly useful when two or more persons are collaborating to annotate an image, as a Shape list selected by one user can be sent to a second user for further additions or modifications.

Transmission component 910 is configured to transmit communications (e.g., wired, wireless) to another apparatus. Transmission component 910 may perform signal processing on the generated communications, and may transmit the processed signals. In some embodiments, the transmission component 910 may include one or more antennas, a transmit processor, a controller/processor, a memory, or a combination thereof. In some embodiments, the transmission component 910 may be co-located with the reception component 908 such as in a transceiver and/or a transceiver component. By transmission component 910, an output image (i.e., output image 800 of FIG. 8) can be received at base image rendering component 900. It is also possible to send a Shape list in JSON format by reception component 910. Transmission capability is also useful when two or more persons are collaborating to annotate an image, as a Shape list selected by one user can be sent to a second user for further additions or modifications.

Storing component 912 may be configured to or may comprise means for storing Shape list 904. Shape list 904 can be stored in a database according to preset parameters. Storing component 912 may store Shape list 904 in a storage location local to a device or storage may occur in some external database, external server, or web application.

Retrieving component 914 may be configured to or may comprise means for retrieving Shape list 904 from a database. Retrieving component 914 Is configured for identifying and extracting Shape list 904 based on a query provided by the user or application. Applications and software generally use various queries to retrieve data in different formats and embodiments are not limited to any specific applications. Retrieving component 914 may be configured to automatically or periodically retrieve Shape list 904 from a device's internal storage or from external storage or from a network location and thus provides a way for multiple users to dynamically collaborate on image annotation in real time.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

1. A method of annotating an image, the method comprising:
retrieving an input image;
displaying a canvas containing said input image and a plurality of shapes, wherein for each shape in said plurality of shapes, a shape class is defined having its own logic to draw, edit and move the shape;
receiving one or more user inputs corresponding to the addition of one or more shapes at one or more coordinates;
storing the one or more shapes and their coordinates in JavaScript Object Notation (JSON) on a shape list; and
traversing the shape list to draw on the canvas all stored Shapes on the input image.

2. The method according to claim 1, further comprising storing in memory an output image bitmap combining the input image and the shapes in the shape list on the canvas.

3. The method according to claim 1, further comprising providing on the canvas an indicator for undo and redo functions to remove or add back the most recently added or deleted shapes from or to the shape list.

4. The method according to claim 1, further comprising providing on the canvas an indicator for a clear function to remove a shape on the canvas next selected by the user from the shape list.

5. The method according to claim 1, further comprising:
calculating a scale between using an input image and two or more devices arranged in a physical space represented by the input image;
establishing a network communications linkage between a first device configured for annotation of images using JSON and a second device;
receiving a signal from the second device at the first device calculated to indicate the location of the second device;
storing a shape on the shape list of the first device based on the location indicated by the second device and the calculated scale.

6. The method according to claim 1, wherein the user inputs corresponding to the addition of one or more shapes at one or more coordinates are received through at least one of:
a keyboard;
a cursor control device;
a wearable device;
a microphone; and
a camera.

7. The method according to claim 1, further comprising receiving a user input to save the shape list according to one or more parameters provided by the user.

8. The method according to claim 1, wherein the one or more user inputs corresponding to the addition of one or more shapes at one or more coordinates are received dynamically based on variables which cause the one or more inputs corresponding to the addition of one or more shapes at one or more coordinates to change.

9. The method according to claim 1, further comprising transmitting the shape list stored in JavaScript Object Notation (JSON) over a communications network to a server.

10. The method according to claim 1, further comprising transmitting a bitmap of the output image composite of the input image and the shape list over a communications network to a server.

11. An apparatus for annotating an image, the apparatus comprising:
a memory storage storing computer-executable instructions; and
a processor communicatively coupled to the memory storage, wherein the processor is configured to execute the computer-executable instructions and cause the apparatus to:
retrieve an input image;
display a canvas containing said input image and a plurality of shapes, wherein for each shape in said plurality of shapes a shape class is defined having its own logic to draw, edit and move the shape;
receive, from a user, one or more inputs corresponding to the addition of one or more shapes at one or more coordinates;
store the one or more shapes selected by the user in JavaScript Object Notation (JSON) in a shape list; and
traverse the shape list to draw on the canvas one by one all stored shapes on the input image.

12. The system according to claim 11, further comprising a network connection module configured to transmit data over a computer communications network to a server.

13. The system according to claim 12, wherein the computer-executable instructions, when executed by the processor, further cause the apparatus to transmit the Shape list stored in JSON.

14. The system according to claim 12, wherein the computer-executable instructions, when executed by the processor, further cause the apparatus to transmit an output image bitmap combining the input image and the shapes in the shape list on the canvas.

15. A non-transitory computer-readable medium containing instructions, which when executed by one or more processors cause an apparatus to:
retrieve an input image;
display a canvas containing said input image and a plurality of shapes, wherein for each shape in said plurality of shapes a shape class is defined which has its own logic to draw, edit and move the Shape;
receive, from a user, one or more inputs corresponding to the addition of one or more shapes at one or more coordinates;
store the one or more shapes selected by the user in JavaScript Object Notation (JSON) in a shape list; and
traverse the shape list to draw on the canvas one by one all stored shapes on the input image.

16. The non-transitory computer-readable medium according to claim 15, wherein the instructions cause the apparatus to provide on the canvas an indicator for undo and redo functions to remove or add back the most recently added or deleted shapes from or to the shape list.

17. The non-transitory computer-readable medium according to claim 15, wherein the instructions cause the apparatus to provide on the canvas an indicator for a clear function to remove a shape on the canvas next selected by the user from the shape list.

18. The non-transitory computer-readable medium according to claim 15, wherein the instructions cause the apparatus to display a plurality of shapes calculated based on parameters related to locations of telecommunications equipment and/or telecommunication service availability.

19. The non-transitory computer-readable medium according to claim 15, wherein the instructions cause the apparatus to transmit the shape list stored in JSON over a computer communications network to a server.

20. The non-transitory computer-readable medium according to claim 15, wherein the instructions cause the apparatus to transmit a bitmap of an output image which is a composite of the input image and the Shape list over a computer communications network to a server.
